(19) United States
(12) Patent Application Publication
(10) Pub. No.: US 2002/0109917 A1
(43) Pub. Date: Aug. 15, 2002

(54) Polarization insensitive variable optical attenuator

(76) Inventors: Stephen F. Sagan, Lexington, MA (US); Dwight L. Ritums, Mountain View, CA (US)

Correspondence Address: Digilens Inc., c/o John Gunther, 615 Palomar Avenue, Sunnyvale, CA, 94086, US

(21) Appl. No.: 10/074,653

(22) Filed: Feb. 13, 2002

Related U.S. Application Data
(60) Provisional application No. 60/269,070, filed on Feb. 14, 2001.

(51) Int. Cl. G02F 1/13; G02B 5/30; G02B 27/28; G02B 5/18

(52) U.S. Cl. 359/484; 359/483; 359/573; 349/201

(57) ABSTRACT

An apparatus is disclosed for an electrically variable optical attenuator. The apparatus is comprised of an Electrically Switchable Bragg Grating device and a polarization-converting reflector. The polarization-converting reflector may be a one-quarter-wave retardation plate or a 45-degree Faraday rotation plate in combination with a mirror. The electrically variable optical attenuator is suited for use in fiber optic communications systems.

This application claims priority to the provisional application entitled “Polarisation insensitive variable optical attenuator,” Serial. No. 60/269,070, filed Feb. 14, 2001.

### BACKGROUND OF THE INVENTION

This invention relates to a variable optical attenuator for use in optical telecommunications networks. Specifically, the present invention provides a polarization insensitive Variable Optical Attenuator (VOA) based on an Electrically Switchable Bragg Grating (ESBG).

ESBGs are well-known optical components formed by recording a Bragg grating (also commonly termed a volume phase grating or hologram) in a polymer dispersed liquid crystal (PDLC) mixture. Typically, ESBG devices are fabricated by first placing a thin film of a mixture of photopolymerizable monomers and liquid crystal material between parallel glass plates. One or both glass plates support electrodes, typically transparent indium tin oxide films, for applying an electric field across the PDLC layer. A Bragg grating is then recorded by illuminating the liquid material with two mutually coherent laser beams, which interfere to form the desired grating structure. During the recording process, the monomers polymerise and the PDLC mixture undergoes a phase separation, creating regions densely populated by liquid crystal micro-droplets, interspersed with regions of clear polymer. The alternating liquid crystal-rich and liquid crystal-depleted regions form the fringe planes of the grating. The resulting volume phase (Bragg) grating can exhibit very high diffraction efficiency, which may be controlled by the magnitude of the electric field applied across the PDLC layer. When an electric field is applied to the hologram via electrodes, the natural orientation of the LC droplets is changed causing the refractive index modulation of the fringes to reduce and the hologram diffraction efficiency to drop to very low levels. Note that the diffraction efficiency of the device can be adjusted, by means of the applied voltage, over a continuous range from essentially zero to near 100%.

U.S. Pat. No. 5,942,157 by Sutherland et al. and U.S. Pat. No. 5,751,452 by Tanaka et al. describe monomer and liquid crystal material combinations suitable for fabricating ESBG devices. A recent publication by Butler et al. (“Diffractive properties of highly birefringent volume gratings: investigation”, Journal of the Optical Society of America B, Volume 19 No. 2, February 2002) describes analytical methods useful to design ESBG devices and provides numerous references to prior publications describing the fabrication and application of ESBG devices.

The diffractive properties of ESBG devices can vary substantially with the polarization state of the incident light. In particularly, ESBG transmission gratings may have high diffraction efficiency for light having a specific linear polarization state and virtually zero diffraction efficiency for light of the orthogonal polarization state. The polarization dependence of liquid crystal-polymer composite gratings can be of great use in some applications, such as illumination systems for liquid crystal displays. However, in a typical fiber optic communications system, the orientation of the electric field vector (i.e. the polarization) of the information-carrying light will vary in time due to fluctuations in the light source, thermal variations and other effects. To avoid corresponding adverse fluctuations in the signal power, components for fiber optic communications must have properties that are essentially polarization independent.

Thus it is the object of the present invention to provide an essentially polarization-insensitive variable optical attenuator based on an ESBG device. Compared to existing optical attenuator components, the present invention will provide very fast response time, low power operation, and wide wavelength bandwidth and dynamic range.

### BRIEF DESCRIPTION OF THE DRAWINGS

FIG. 1 is a schematic illustration of the optical device of the present invention.

### DETAILED DESCRIPTION OF THE INVENTION

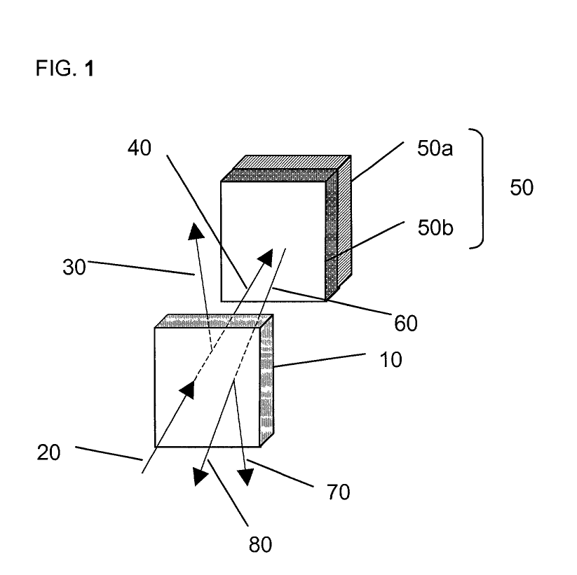

As shown schematically in FIG. 1, the invention is comprised of an ESBG device 10 and a polarization-converting reflector 50. The ESBG device 10 receives a collimated input beam 20. In a fiber optic communications application, a lens, not shown in FIG. 1, would commonly be used to collimate the light exiting an optical fiber. Upon transmission through the ESBG device 10, the light beam is divided into a diffracted component 30 and an undiffracted component 40. While the diffracted component 30 is shown as being transmitted through the ESBG device 10, the diffracted component could be reflected from the ESBG device.

As previously described, the diffraction efficiency of the ESBG device can be controlled by means of the applied voltage, such that the portion of the input beam that is diffracted can be varied from essentially zero to some maximum value determined by the design of the ESBG device. Thus the amplitude of the undiffracted beam 40 can be attenuated with respect to the input beam 20. However, as previously described, ESBG devices generally do not have the same diffraction efficiency for all polarization states and may only diffract light having a single linear polarization state. Thus the portion of input beam 20 that is directed into the diffracted beam 30, and thus the attenuation level of the undiffracted beam 40, will be different for different polarization states of the input beam 20.

The undiffracted beam 40 is reflected by the polarization-converting reflector 50 such that the reflected beam 60 has a polarization state that is rotated by 90 degrees with respect to the polarization state of the undiffracted beam 40. There are several well-known combinations of optical components that can be used to form a polarization-converting reflector. Specifically, the polarization-converting reflector 50 may be comprised of a mirror 50a and a one-quarter wave retarder 50b, in which case the retarder must be oriented with its optical axis at a 45-degree angle with respect to the fringe planes in the ESBG device. Alternately, the polarization-converting reflector 50 may be comprised of a mirror 50a and a 45-degree Faraday rotator 50b, in which case precise alignment of the Faraday rotator is not required.

The reflected beam 60 passes through the ESBG device 10 in the reverse direction. The ESBG device divides again divides this beam into a diffracted component 70 and an undiffracted component 80. The undiffracted component 80 constitutes the output beam of the attenuator, and will commonly be collected by a lens, not shown in FIG. 1, and focused into an optical fiber. The portion of the light that is diffracted and undiffracted for each polarization state within beam 60 will be different for different polarization states. However, since the polarization state of beam 60 has been rotated by 90 degrees with respect to the polarization state of input beam 20, the net attenuation of output beam 80 with respect to input beam 20 will not depend on the polarization state of input beam 20.

The invention may be further understood by means of an example: assume that input beam 20 is comprised of S and P orthogonal linearly polarized components, where the normal definitions are employed for S and P polarization. Further assume that the ESBG device only diffracts light of P polarization such that beam 30 is P polarized and beam 40 is comprised of the undiffracted portion of the P light and all of the S light. After reflection from the polarization-converting reflector 50, beam 60 has a P component equal to the S component of beam 20 and an S component equal to the undiffracted portion of P component of beam 40. After the second transit through the ESBG device, some portion of the P component of beam 60 is diffracted into beam 70 such that output beam 80 is comprised of the undiffracted portions of both the S and P components of the input beam 20. Thus the attenuator is polarization insensitive.

What is claimed is:

1. A variable optical attenuator comprising an Electrically Switchable Bragg Grating device positioned to accept an incident optical beam and divide said incident optical beam into a transmitted undiffracted component and a diffracted component, and a polarization-converting reflector positioned to reflect said undiffracted component back through said Electrically Switchable Bragg Grating device.

2. The device of claim 1 wherein said polarization converting reflector is comprised of a one-quarter-wave retardation plate and a mirror.

3. The device of claim 1 wherein said polarization converting reflector is comprised of a 45-degree Faraday rotation plate and a mirror.
